(19) United States
(12) Patent Application Publication
(10) Pub. No.: US 2019/0000126 A1
(43) Pub. Date: Jan. 3, 2019

(54) COMPOSITIONS AND METHODS FOR ENHANCING ATHLETIC PERFORMANCE

(71) Applicant: Corr-Jensen Inc., New York, NY (US)

(72) Inventor: Matthew Hesse, New York, NY (US)

(21) Appl. No.: 15/735,481

(22) PCT Filed: Jan. 7, 2016
(86) PCT No.: PCT/US2016/012447

§ 371 Date: Dec. 11, 2017

Related U.S. Application Data
(60) Provisional application No. 62/100,733, filed on Jan. 7, 2015.

(51) Int. Cl. A23L 33/175; A23L 33/115; A23L 33/15; A23L 33/105; A23L 2/39; A23L 33/16

(52) U.S. Cl. CPC A23L 33/175; A23L 33/115; A23L 33/15; A23V 2002/00; A23L 2/39; A23L 33/16; A23L 33/105

(57) ABSTRACT

A powder blend comprising (a) an immediate release powder comprising at least one performance enhancing component and (b) extended release granules comprising a core. The core of the extended release granules comprises at least one performance enhancing component and one or more fatty materials. The immediate release powder is soluble in an aqueous medium, while the extended release granules are formulated to exhibit neutral buoyancy in an aqueous medium.

### CROSS-REFERENCE TO RELATED APPLICATION

This application depends from and claims priority to U.S. Provisional Application No. 62/100,733 filed Jan. 7, 2015, the entire contents of which are incorporated herein by reference.

### FIELD

The invention relates to exercise and sports performance. More specifically, compositions and methods are provided that enhance exercise performance.

### BACKGROUND

Nutritional requirements play a key role improving athlete endurance and performance. With the entrance of Gatorade® and other similar sports drinks beginning in the mid 1960's more attention has been paid to understanding the role of various nutrients on human performance in athletic events.

Sports drinks and energy supplying supplements historically focused on obtaining quick bursts of energy that can be capitalized on during exercise. These quick bursts of energy, however, are of short duration requiring the user to either consume additional supplement or rely on self-contained energy stores.

There is thus a need in the art to provide a sustained and controlled supply of nutrients to individuals without the necessity of excess food intake.

### SUMMARY

It is understood that both the following summary and the detailed description are exemplary and explanatory and are intended to provide further explanation of the disclosure as claimed. Neither the summary nor the description that follows is intended to define or limit the scope of the disclosure to the particular features mentioned in the summary or description.

One object is to provide a sustained and controlled supply of nutrients to individuals without the necessity of excess food intake. This object is achieved in the present disclosure that provides a performance enhancing immediate and extended release powder blend. In certain aspects, the powder blend comprises (a) an immediate release powder comprising at least one performance enhancing component and (b) extended release granules comprising a core. The core of the extended release granules comprises at least one performance enhancing component and one or more fatty materials. The immediate release powder is soluble in an aqueous medium, while the extended release granules are formulated to exhibit neutral buoyancy in an aqueous medium.

In another aspect, an aqueous performance enhancing immediate and extended release oral suspension is provided. In some aspect, the oral suspension comprises (a) an immediate release component comprising at least one performance enhancing component; (b) extended release granule component comprising a core, the core comprising at least one performance enhancing component and one or more fatty materials; and (c) a dispersion medium.

In a further aspect, a performance enhancing immediate and extended release composition is provided. The composition comprises (a) an immediate release powder comprising at least one first performance enhancing component, wherein the at least one first performance enhancing component is selected from the group consisting beta alanine, betaine anhydrous, citrulline malate, creatine, N-acetyl L-tyrosine, caffeine, niacinamide, and bioperine black pepper extract; (b) extended release granules comprising a core and a barrier coating layer over the core, the core comprising at least one second performance enhancing component, and one or more fatty material, and one or more swellable polymers; wherein the at least one second performance enhancing component is selected from the group consisting of betaine, caffeine, niacin, N-acetyl L-tyrosine citrus aurantium, alpha yohimbine, and vitamin 12; wherein the one or more fatty material comprises hydrogenated vegetable oil; wherein the one or more swellable polymers is selected from the group consisting of microcrystalline cellulose and hydroxypropyl methylcellulose; wherein the barrier coating layer comprises hydroxypropyl methylcellulose and ethylcellulose; and wherein the immediate release powder is soluble in an aqueous medium.

In another aspect, a performance enhancing immediate and extended release composition is provided, the composition comprising: (a) an immediate release powder comprising at least one first performance enhancing component, wherein the at least one first performance enhancing component is selected from the group consisting of leucine, isoleucine, valine, betaine anhydrous, citrulline, glutamine, and branched chain amino acids, coconut water powder, astragalus membranaceus and panax notoginseng, and piper nigrum fruit extract; (b) extended release granules comprising a core and a barrier coating layer over the core, the core comprising at least one second performance enhancing component, and one or more fatty material, and one or more swellable polymers; wherein the at least one second performance enhancing component is selected from the group consisting of leucine and branched chain amino acids; wherein the one or more fatty material comprises hydrogenated vegetable oil; wherein the one or more swellable polymers is selected from the group consisting of microcrystalline cellulose and hydroxypropyl methylcellulose; wherein the barrier coating layer comprises ethylcellulose; and wherein the immediate release powder is soluble in an aqueous medium.

Another aspect provides a performance enhancing immediate and extended release composition comprising: (a) an immediate release powder comprising at least one first performance enhancing component, wherein the at least one first performance enhancing component is selected from the group consisting of citrulline, agmatine sulfate, arginine silicate inositol, norvaline, niacin, aswagandha extract, and piper nigrum fruit extract; (b) extended release granules comprising a core and a barrier coating layer over the core, the core comprising at least one second performance enhancing component, and one or more fatty material, and one or more swellable polymers; wherein the at least one second performance enhancing component is selected from the group consisting of norvaline, niacin, and grape seed extract polyphenols; wherein the one or more fatty material comprises hydrogenated vegetable oil; wherein the one or more swellable polymers is selected from the group consisting of microcrystalline cellulose and hydroxypropyl methylcellulose; wherein the barrier coating layer comprises ethylcellulose; and wherein the immediate release powder is soluble in an aqueous medium.

A further aspect provides a process for reducing fatigue in a subject. The process comprises administering to the subject an immediate and extended release composition and reducing fatigue in said subject by said step of administering. The composition comprises: (a) an immediate release powder comprising at least one first performance enhancing component; and (b) extended release granules comprising a core, the core comprising at least one second performance enhancing component and one or more fatty materials. The immediate release powder is soluble in an aqueous medium.

### DETAILED DESCRIPTION

The following description of particular aspect(s) is merely exemplary in nature and is in no way intended to limit the scope of the invention, its application, or uses, which may, of course, vary. The invention is described with relation to the non-limiting definitions and terminology included herein. These definitions and terminology are not designed to function as a limitation on the scope or practice of the invention but are presented for illustrative and descriptive purposes only. While the compositions or processes are described as using specific materials or an order of individual steps, it is appreciated that materials or steps may be interchangeable such that the description of the invention may include multiple parts or steps arranged in many ways as is readily appreciated by one of skill in the art.

It will be understood that, although the terms “first.” “second.” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus. “a first element,” “component,” “region,” “layer,” or “section” discussed below could be termed a second (or other) element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

Provided are compositions that include two or more performance enhancing supplements for immediate and time released (e.g. sustained or delayed) performance enhancement, such as maintaining vasodilation during and after a workout and stimulating muscle synthesis and repair over an extending period of time, and/or preventing athletic fatigue, such as sustaining energy levels and avoiding a subsequent energy level crash, when consumed simultaneously by a subject. Additionally, such compositions can be used for:
Immediate and time release sleep recovery with time release melatonin/antioxidants to fall and stay asleep through the night (e.g., comprising melatonin, vitamin c, super fruits such as blueberry and acai, etc.)
Immediate and time release metabolism boosters for weight loss (e.g. comprising green tea, citrus aurantium, citrus sinensis, chromium, etc.)
Immediate and time release appetite suppressants to curb appetite in both the short term and over the course of the day (e.g. comprising garcinia cambogia, hoodia gordonii, 5-HTP, etc); and
Immediate and time release multi vitamin nutritional supplement to supply nutrients throughout the day.

As such, a composition includes a first immediate release component and a second extended release component. A first immediate release component provides one or more performance enhancing supplements for enhancing exercise performance that are rapidly bioavailable and capable of rapid function. A second extended release component includes one or more performance enhancing supplements formulated for sustained release, such that the second component provides a sustained performance. In certain aspects, a second extended release component includes one or more performance enhancing supplements formulated for sustained release, delayed release, or both, such that the second component provides a sustained performance, a latter performance burst, or combinations thereof. In some aspects, the second component comprises extended release granules, delayed release granules, or both extended and delayed release granules. The granules can comprise a core, with the core of the extended release granules comprises at least one performance enhancing component and one or more fatty materials. In certain aspects, the extended release granules, delayed release granules, or both extended and delayed release granules are formulated to be neutrally buoyant or become buoyant when exposed to a dispersion medium, such as an aqueous medium. In some aspects, the composition is a performance enhancing immediate and extended release powder blend. The powder blend may be mixed with a dispersion medium, which is optionally an aqueous solution, to form an orally administrable extended release oral suspension. In other aspects, the composition is a performance enhancing immediate and extended release oral suspension.

As used herein, the term “performance” means performance in athletics. Performance means strong, precise, controlled movements over the time desired by an athlete to achieve a particular result of strength, speed, power and/or precision. “Athlete” is herein defined as a mammal who performs such movements, either in competition or for recreation. Athletes illustratively include cyclists, swimmers, bodybuilders, racehorses, racing dogs and the like. An increase in athletic performance is measured as higher power output, more stamina, or faster speed, optionally in combination with precision of movement or an increase in frequency of performance or movements.

The term “fatigue” as used herein means the inability to maintain a consistent level of peak athletic performance for a desired period of time. Fatigue is this definition may be due to: the exhaustion of energy sources to metabolize; buildup of toxic metabolites in muscle and the like; but not due to lack of sleep, metabolic disease, or illness.

As used herein, the term “performance enhancing supplement” is intended to encompass a chemical composition that functions to enhance exercise performance, prevent reduction in exercise performance, prevent fatigue, or combinations thereof. As such, a composition includes a first immediate release component and a second extended release component. A performance enhancing supplement optionally includes one or more of a “performance enhancing component.” A performance enhancing component is intended to encompass one or more of a: vitamin (e.g. vitamin B12 (optionally in the form of methycobalamin available from Anmar), vitamin B3 (optionally in the form of nicinaminde/nicotinamide available from DSM) among others); beta-alanine or derivative thereof (optionally CARNOSYN available from Natural Alternatives Intl.), mineral; protein; amino acid (e.g. arginine (optionally in the form of arginine silicate inositol available as Nitrosigine from Nutrition 21, or agmatine sulfate available from Parchem) glutamine (available from Kyowa Hakko), creatine (optionally in the form of creatine HCL available from Pharmline), camitine, glycine, trimethyl glycine, tyrosine, leucine (available from Glanbia or Danisco), isoleucine (available from Glanbia), valine (available from Glanbia), citrulline (optionally in the form of citrulline malate available from Creative Compounds), among others or derivatives thereof optionally N-acetyl L-tyrosine (available from Cepham); branched-chain amino acids (optionally in the form of Pepform 2:1:1 BCAA containing a 2:1:1 ratio of leucine, isoleucine and valine, available from Glanbia); astragalus membranaceus and panax notoginseng carbohydrate (optionally in the form of Astragin available from N Liv Science); fatty acid (optionally essential fatty acid); stimulant illustratively caffeine (optionally 1,3,7-trimethylxanthine available from Mitsubishi), ephedrine, or forskholin; pyruvate; a citric acid cycle intermediate; betaine (optionally in the form of betaine anhydrous available from Danisco), norvaline (optionally in the form of L-novaline, available from Cepham), one or more plant components such as an essential oil or plant extract (illustratively citrus aurantium, grape seed extract, or piper nigrum (available from Indena)), ashwagandha extract (optionally KSM66 from Ixoreal), or a derivative of any of the foregoing. In certain aspects, the performance enhancing supplement of the instant disclosure can be a performance enhancing immediate and extended release powder blend. In other aspects, the performance enhancing supplement of the instant disclosure is an aqueous performance enhancing immediate and extended release oral suspension. Thus, the instantly-disclosed immediate and extended release performance enhancing supplement compositions can maintaining vasodilation during and after a workout, stimulate muscle synthesis and repair over an extending period of time, and/or preventing athletic fatigue, such as sustaining energy levels and avoiding a subsequent energy level crash, when consumed simultaneously by a subject.

In one aspect, the instant disclosure provides a performance enhancing immediate and extended release powder blend. In certain aspects, the powder blend comprises an immediate release powder comprising at least one performance enhancing component and extended release granules comprising a core. The core of the extended release granules comprises at least one performance enhancing component and one or more fatty materials to provide a desired buoyancy in an aqueous medium. In certain aspects, the immediate release powder is soluble in an aqueous medium. In some aspects, the performance enhancing immediate and extended release powder blend is reconstitutable into a dispersion medium, which is optionally an aqueous solution.

The performance enhancing immediate and extended release powder blend includes an immediate release powder comprising at least one performance enhancing component. The term “immediate release” is the release of the at least one performance enhancing component from the immediate release powder of the powder blend where the rate of release is not retarded by means of a controlled release matrix, coating, or other such means, and where the components of the at least one performance enhancing component from the immediate release powder are designed such that, upon ingestion, maximum exposure of said at least one performance enhancing component from the immediate release powder to body tissues occurs in the minimum period of time. As described herein, an “immediate release” powder preferably releases at least one performance enhancing component in less than about 10 minutes, in about 5 minutes, in about 3 minutes, in about 2 minutes, or as soon as about 1 minute. The at least one performance enhancing component of the immediate release powder is optionally water soluble or partially water soluble so as to be effectively and immediately suspendable in a dispersion medium (e.g. an aqueous medium) upon dilution for a time sufficient to allow consumption.

In some aspects, the at least one performance enhancing component of the immediate release powder is suitable to enhance exercise performance, such as maintaining vasodilation during and after a workout and stimulating muscle synthesis and repair over an extending period of time, and/or preventing athletic fatigue, such as sustaining energy levels and avoiding a subsequent energy level crash. The at least one performance enhancing component of the immediate release powder is illustratively one or more a: vitamin (e.g. vitamin B12 (optionally in the form of methycobalamin available from Anmar), vitamin B3 (optionally in the form of nicinaminde/nicotinamide available from DSM) among others); beta-alanine or derivative thereof (optionally CARNOSYN available from Natural Alternatives Intl.), mineral; protein; amino acid (e.g. arginine (optionally in the form of arginine silicate inositol available as Nitrosigine from Nutrition 21, or agmatine sulfate available from Parchem) glutamine (available from Kyowa Hakko), creatine (optionally in the form of creatine HCL available from Pharmline), camitine, glycine, trimethyl glycine, tyrosine, leucine (available from Glanbia or Danisco), isoleucine (available from Glanbia), valine (available from Glanbia), citrulline (optionally in the form of citrulline malate available from Creative Compounds), among others or derivatives thereof optionally N-acetyl L-tyrosine (available from Cepham); branched-chain amino acids (optionally in the form of Pepform 2:1:1 BCAA containing a 2:1:1 ratio of leucine, isoleucine and valine, available from Glanbia); astragalus membranaceus and panax notoginseng carbohydrate (optionally in the form of Astragin available from N Liv Science); fatty acid (optionally essential fatty acid); stimulant illustratively caffeine (optionally 1,3,7-trimethylxanthine available from Mitsubishi), ephedrine, or forskholin; pyruvate; a citric acid cycle intermediate; betaine (optionally in the form of betaine anhydrous available from Danisco), norvaline (optionally in the form of L-novaline, available from Cepham), one or more plant components such as an essential oil or plant extract (illustratively citrus aurantium, grape seed extract, or piper nigrum (available from Indena)), ashwagandha extract (optionally KSM66 from Ixoreal), or a derivative of any of the foregoing. In certain aspects, the at least one performance enhancing component of the immediate release powder is an uncoated performance enhancing component.

The at least one performance enhancing component of the immediate release powder is present to provide an in vivo concentration effective to function to improve athletic performance, such as maintaining vasodilation during and after a workout and stimulating muscle synthesis and repair over an extending period of time, and/or preventing athletic fatigue, such as sustaining energy levels and avoiding a subsequent energy level crash. In certain aspects, the at least one performance enhancing component of the immediate release powder is optionally present at a weight percent of the performance enhancing immediate and extended release powder blend of about 5% to about 50%, or any value or range therebetween. For example, the at least one performance enhancing component of the immediate release powder is optionally present at a weight percent of about 5% to about 10%, about 10% to about 15%, about 15% to about 20%, about 20% to about 25%, about 25% to about 30%, about 30% to about 35%, about 35% to about 40%, about 40% to about 45%, about 45% to about 50%, or any value or range therebetween.

In certain aspects, the immediate release powder optionally includes one or more excipients including but not limited to, e.g., one or more of a sweetener, a preservative, sodium citrate; silica; flavorants, colorants, preservatives, or other components. The choice of which such materials to use, if any, and the amounts to be utilized are considered to be within the abilities of one of skilled in the art, in view of the disclosure herein.

Exemplary sweeteners may include those sweeteners well known in the art, including both natural and artificial sweeteners. Thus, exemplary sweeteners may include water-soluble sweetening agents such as monosaccharides, disaccharides, and polysaccharides such as xylose, ribose, glucose, mannose, galactose, fructose, high fructose corn syrup, dextrose, sucrose, sugar, maltose, partially hydrolyzed starch, or corn syrup solids and sugar alcohols such as sorbitol, xylitol, mannitol and mixtures thereof. Additional exemplary sweeteners include optionally sugar or sugar substitute (e.g. sucralose (1,6-Dichloro-1,6-dideoxy-3-D-fructofuranosyl-4-chloro-4-deoxy-α-D-galactopyranoside), aspartame, and the like.

Exemplary preservatives may include sodium benzoate, benzoic acid, potassium sorbate, salts of edetate (also known as salts of ethylenediaminetetraacetic acid, or EDTA, such as disodium EDTA), parabens (e.g., methyl, ethyl, propyl or butyl-hydroxybenzoates, etc.), and sorbic acid. Other chelating agents, e.g., nitrilotriacetic acid (NTA); ethylenediaminetetracetic acid (EDTA), hydroxyethylethylenediaminetriacetic acid (HEDTA), diethylenetriaminepentaacetic acid (DPTA), 1,2-Diaminopropanetetraacetic acid (1,2-PDTA); 1,3-Diaminopropanetetraacetic acid (1,3-PDTA); 2,2-ethylenedioxybis[ethyliminodi(acetic acid)] (EGTA); 1,10-bis(2-pyridylmethyl)-1,4,7,10-tetraazadecane (BPTETA); ethylenediamine (EDAMINE); Trans-1,2-diaminocyclohexane-N,N,N′,N′-tetraacetic acid (CDTA); ethylenediamine-N,N′-diacetate (EDDA); phenazine methosulphate (PMS); 2,6-Dichloro-indophenol (DCPIP); Bis(carboxymethyl)diaza-18-crown-6 (CROWN); porphine; chlorophyll; dimercaprol (2,3-Dimercapto-1-propanol); citric acid; tartaric acid; fumaric acid; malic acid; and salts thereof can be utilized as preservatives. Each preservative must be evaluated in each formulation to assure the compatibility and efficacy of the preservative. Methods for evaluating the efficacy of preservatives in compositions and formulations are known to those skilled in the art.

Exemplary flavorings may include both natural and artificial flavors, and mints such as peppermint, menthol, artificial vanilla, chocolate, cinnamon, various fruit flavors, both individual and mixed, essential oils (i.e. thymol, eucalyptol, menthol and methyl salicylate) and the like.

In some aspects, the immediate release powder of the performance enhancing immediate and extended release powder blend can include a viscosity modifier. In certain aspect, the viscosity modifier can include one or more of guar gum, xantham gum, and silica.

The powder blend of the instant disclosure can further comprise extended release granules, delayed release granules, or both extended and delayed release granules. In some aspects, the extended release granules, delayed release granules, or both extended and delayed release granules are formulated to be neutrally buoyant or become buoyant when exposed to a dispersion medium, such as an aqueous medium. In certain aspects, the extended release granules, delayed release granules, or both extended and delayed release granules are formulated to be neutrally buoyant or become buoyant when exposed to an aqueous solution. Thus, when the extended release granules, delayed release granules, or both extended and delayed release granules are exposed to a dispersion medium, such as an aqueous medium, the granules exhibit a neutral buoyancy and are suspendable, without either sinking or floating. In certain aspects, the extended release granules, delayed release granules, or both extended and delayed release granules will remain suspended once dispersed in an aqueous medium, without either sinking or floating within about the first 15 seconds to about 1 and 15 seconds of agitation.

In some aspects, the extended release granules, delayed release granules, or both extended and delayed release granules have a bulk density that provides the desired the desired buoyancy of the granules. The term “bulk density,” as used herein, refers to a property of particles and is defined as the mass of many particles of the material divided by the total volume they occupy. A bulk density of from about 0.3 g/cc to about 0.7 g/cc, including any value or range therebetween, in combination with other factors such a particle size, morphology, surface tension, pH, etc, provides the desired neutral buoyancy of the extended release granules, delayed release granules, or both extended and delayed release granules in an aqueous medium. Thus, the extended release granules, delayed release granules, or both extended and delayed release granules can have a bulk density of 0.3-0.35 g/cc, 0.35-0.40 g/cc, 0.40-0.45 g/cc, 0.45-0.50 g/cc, 0.50-0.55 g/cc, 0.55-0.60 g/cc, 0.60-0.65 g/cc, 0.65-0.70 g/cc, and 0.70-0.75 g/cc in an aqueous medium, including any value or range therebetween. The bulk density of the extended release granules, delayed release granules, or both extended and delayed release granules will vary, and depends of the entirety of the formulation (e.g. the components of the powder blend or the powder blend dispersed in a dispersion medium). For example, when the powder blend is dissolved in a dispersion medium, such variation can be due to the dissolved solids from the immediate release powder of the powder blend. As such, the higher the amount of dissolved solids in the dispersion medium (e.g. aqueous medium), the actual density of the dispersion medium can increase. Further, the viscosity modifiers that can be included in the immediate release powder, once dispersed in a dispersion medium, can act to suspend the extended release granules, delayed release granules, or both extended and delayed release granules. Additionally, other factors that may vary within the immediate release powder, which ultimately impacts the dispersion medium once dissolved, can impact the final buoyancy of the granules. Such factors include pH, hydrophilicity/hydrophobicity, and temperature. All of these factors should be accounted for to ensure that the extended release granules, delayed release granules, or both extended and delayed release granules have a bulk density that provides the desired neutral buoyancy of the granules when dispersed in a dispersion medium, e.g. an aqueous medium.

In certain aspects, the powder blend can comprise extended release granules comprising a core. The core of the extended release granules comprises at least one performance enhancing component and one or more fatty materials. The term “extended release” refers to the gradual release of the at least one performance enhancing component from the extended release granules of the powder blend over an extended period of time. With extended release, the rate of release of the at least one performance enhancing component from the extended release granules is reduced in order to maintain therapeutic activity of the at least one performance enhancing component for a longer period of time. As described herein, an “extended release” granule preferably releases not less than 80% of the at least one performance enhancing component in about 5 hours, e.g., in about 5 hours, in about 4 hours, in about 3 hours, in about 2 hours, in about 1 hour, in about 50 minutes, in about 40 minutes, or any value or range therebetween. In certain aspects, an “extended release” granule preferably releases not more than 20% of the at least one performance enhancing component in about 1 hour, in about 50 minutes, in about 40 minutes, in about 30 minutes, in about 20 minutes, or any value or range therebetween. In other aspects, an “extended release” granule preferably releases not more than 10% of the at least one performance enhancing component in about 1 hour, in about 50 minutes, in about 40 minutes, in about 30 minutes, in about 20 minutes, or any value or range therebetween.

In certain aspects, the powder blend can comprise delayed release granules comprising a core. The core of the delayed release granules comprises at least one performance enhancing component and one or more fatty materials. The term “delayed release” refers to modified release in which the release of the at least one performance enhancing component from the extended release granules of the powder blend is delayed after oral administration for a finite period of time after which release of the drug is unhindered.

The extended release granules, delayed release granules, or both extended and delayed release granules of the powder blend can be manufactured using methods of granulating that are known in the art. Such methods include, but are not limited to, dry and wet granulation technology, including fluid bed granulation, high shear granulation, extrusion and spheronization, and spay drying. In certain aspects, the extended release granules, delayed release granules, or both extended and delayed release granules are manufactured using high shear granulation optionally substantially as described in U.S. Pat. No. 5,462,747 or U.S. Pat. No. 6,953,593.

In some aspects, the core of the extended release granules, delayed release granules, or both extended and delayed release granules can include one or more fatty materials. In some aspects, the one or more fatty materials include low density fatty materials. In some aspects, the one or more fatty materials include powdered fats, and in certain aspects, low density powdered fats. The one or more powered fats can include hydrogenated vegetable oil (optionally in the form of Sterotex K, NF or Serotex HM, NF available from Abitec), stearic acid, fractioned oils, such as fractionated vegetable oils including coconut, palm, etc, medium chain triglycerides, monoglycerides, such as glycerol nehenate, glycerol monosterate, and glycerol esters of long chain fatty acids. Without being bound by theory, the addition of the one or more fatty materials to the core of the extended release granules, delayed release granules, or both extended and delayed release granules can be used to adjust the density of the granule to provide the previously-described neutral buoyancy of the granules in a dispersion medium, such as an aqueous medium.

When one or more fatty materials are present in the core of the extended release granules, delayed release granules, or both extended and delayed release granules, such fatty material preferably comprises up to about 50% by weight of the total formulation, including about 0.1% by weight to about 50% by weight, including about 0.1%, 0.5%, 1%, 5%, 10%, 20%, 30%, 40%, and 50% by weight and ranges encompassing and bordered by such amounts. Optionally, the fatty material is present at 15% to 50%/0 by weight. The amount of fatty material utilized may be governed, at least in part, by the amounts and physical characteristics of the at performance enhancing components of the immediate release component and extended or delayed release granules and any optional swellable polymer(s), barrier coatings, and additives, with the object being to achieve a granule formulation which provides the previously-described neutral buoyancy in a dispersion medium, such as an aqueous medium.

The at least one performance enhancing component of the extended release granules, delayed release granules, or both extended and delayed release granules is present to provide an in vivo concentration effective to function to improve athletic performance, such as maintaining vasodilation during and after a workout, stimulating muscle synthesis and repair over an extending period of time, and/or preventing athletic fatigue, such as sustaining energy levels and avoiding a subsequent energy level crash. In certain aspects, the at least one performance enhancing component of the extended release granules, delayed release granules, or both extended and delayed release granules is optionally present at a weight percent of the performance enhancing immediate and extended release powder blend of about 5% to about 95%, or any value or range therebetween. For example, the at least one performance enhancing component of the extended release granules, delayed release granules, or both extended and delayed release granules is optionally present at a weight percent of about 1% to about 15%, about 1% to about 25%, about 10/o to about 35%, about 25% to about 45%, about 25% to about 55%, or any value or range therebetween. Optionally, the at least one performance enhancing component is present at 1% to 55% by weight or any value or range therebetween. Optionally, the at least one performance enhancing component is present at 0.1% to 20% by weight.

In some aspects, the extended release granules, delayed release granules, or both extended and delayed release granules includes the same, different, additional, or fewer at least one performance enhancing component of relative to the at least one performance enhancing component of the immediate release powder. The at least one performance enhancing component of the extended release granules, delayed release granules, or both extended and delayed release granules is suitable to enhance exercise performance, such as maintaining vasodilation during and after a workout and stimulating muscle synthesis and repair over an extending period of time, and/or preventing athletic fatigue, such as sustaining energy levels and avoiding a subsequent energy level crash. The at least one performance enhancing component of the extended release granules, delayed release granules, or both extended and delayed release granules is illustratively one or more of a: vitamin (e.g. vitamin B12 (optionally in the form of methycobalamin available from Anmar), vitamin B3 (optionally in the form of nicinaminde/nicotinamide available from DSM) among others); beta-alanine or derivative thereof (optionally CARNOSYN available from Natural Alternatives Intl.), mineral; protein; amino acid (e.g. arginine (optionally in the form of arginine silicate inositol available as Nitrosigine from Nutrition 21, or agmatine sulfate available from Parchem) glutamine (available from Kyowa Hakko), creatine (optionally in the form of creatine HCL available from Pharmline), camitine, glycine, trimethyl glycine, tyrosine, leucine (available from Glanbia or Danisco), isoleucine (available from Glanbia), valine (available from Glanbia), citrulline (optionally in the form of citrulline malate available from Creative Compounds), among others or derivatives thereof optionally N-acetyl L-tyrosine (available from Cepham); branched-chain amino acids (optionally in the form of Pepform 2:1:1 BCAA containing a 2:1:1 ratio of leucine, isoleucine and valine, available from Glanbia); astragalus membranaceus and panax notoginseng carbohydrate (optionally in the form of Astragin available from N Liv Science); fatty acid (optionally essential fatty acid); stimulant illustratively caffeine (optionally 1,3,7-trimethylxanthine available from Mitsubishi), ephedrine, or forskholin; pyruvate; a citric acid cycle intermediate; betaine (optionally in the form of betaine anhydrous available from Danisco), norvaline (optionally in the form of L-novaline, available from Cepham), one or more plant components such as an essential oil or plant extract (illustratively citrus aurantium, grape seed extract, or piper nigrum (available from Indena)), ashwagandha extract (optionally KSM66 from Ixoreal), or a derivative of any of the foregoing.

The ratio of at least one performance enhancing component of the immediate release powder to the at least one performance enhancing component of the extended release granules, delayed release granules, or both extended and delayed release granules may be adjusted as desired by one of skill in the formulation art. In some aspects, the ratio of at least one performance enhancing component of the immediate release powder to the at least one performance enhancing component of the extended release granules, delayed release granules, or both extended and delayed release granules ranges from about 1:1 to about 5:1, or any value or range therebetween.

In some aspects, the extended release granules, delayed release granules, or both extended and delayed release granules can comprise a barrier coating. A barrier coat comprises a water-permeable, water-insoluble, non-ionic polymer or co-polymer that confers either extended release or delayed release properties to the granules. In one aspect, the barrier coat can be applied, e.g., as an aqueous suspension, over the extended release granules, delayed release granules, or both extended and delayed release granules, and forms a separate layer thereon. In some aspects, the barrier coat is directly over the extended release granules, delayed release granules, or both extended and delayed release granules and the barrier coat layer, i.e., there are no intervening layers between the barrier coat and the granules. Depending upon the polymeric material selected, the barrier coat polymer or co-polymer may be cured (e.g., poly-vinyl acetate or ethylcellulose-based coatings). In certain aspects, a poly-vinyl acetate based coating may further include a plasticizer. In certain aspects, the barrier coating can comprise poly-vinyl acetate-based coatings, ethylcellulose-based coatings (e.g. SURELEASE™), hydrophobic shellac coatings, or enteric coatings, as are known in the art. Enteric coatings can be used to manufacture delayed release granules. Other barrier coatings can be utilized, e.g., the barrier coatings described in U.S. Pat. No. 6,066,334 and U.S. Pat. No. 6,046,277, U.S. Pat. No. 6,046,277, U.S. Pat. No. 6,001,392, US2007/0215511, US2005/232986, US2005/232987 US2005/232993, US2005/266032, and US2003/009971, which are incorporated herein by reference.

The total amount of the barrier coating present may vary within a wide range, preferably from about 0.1% by weight to about 20% by weight, including about 1% to about 15% by weight, about 5% to about 15% by weight, about 2% to about 10% by weight, and about 2% by weight to about 7.5% by weight of the total composition, including about 1%, 2%, 5%, 7.5%, 10%, 15%, and 20% by weight and ranges encompassing and bordered by such amounts. The amount of the barrier coating component(s) present may depend, at least in part, upon the amount and identity of each of the other components present (e.g. the amounts and physical characteristics of the at performance enhancing components of the immediate release component and extended or delayed release granules and any optional swellable polymer(s), barrier coatings, and additives), and the identity and properties of the particular barrier coating component(s), with the object being to achieve a granule formulation which exhibits extended release or delayed release and which provides the previously-described neutral buoyancy in a dispersion medium, such as an aqueous medium.

In some aspects, the extended release granules, delayed release granules, or both extended and delayed release granules may include one or more swellable polymer that acts to modify, prolong, and/or slow the release over time of the at least one performance enhancing component from the granules. A “swellable polymer” is a polymer that will swell in the presence of a dispersion medium, such as a fluid. Thus, swellable polymers are capable of absorbing water and physically swelling as a result, with the extent to which a polymer can swell being determined by the molecular weight or degree of crosslinking (for crosslinked polymers). The one or more swellable polymer is capable of swelling dimensionally unrestrained in upon contact with a dispersion medium, such as an aqueous medium. Suitable water-swellable polymers include those polymers that swell in a dimensionally unrestrained manner upon contact with water. Such polymers may also gradually erode over time. Examples of such polymers include polyalkylene oxides, such as polyethylene glycols, particularly high molecular weight polyethylene glycols; cellulose polymers and their derivatives including, but not limited to, methylcellulose, ethylcellulose (e.g. SURELEASE™, available from Colorcon as an aqueous ethyl cellulose dispersion containing water (70.6% w/w), ethylcellulose (18.8% w/w), ammonium hydroxide (4.4% w/w), a medium chain triglyceride (4.0% w/w), and oleic acid (2.2% w/w)), hydroxyalkyl celluloses, hydroxymethyl cellulose, hydroxyethyl cellulose, hydroxypropyl cellulose, hydroxypropyl methylcellulose (available from Dow Chemical Company), carboxymethylcellulose, microcrystalline cellulose (available from FMC); polysaccharides and their derivatives; chitosan; poly(vinyl alcohol); xanthan gum; maleic anhydride copolymers; poly(vinyl pyrrolidone); starch and starch-based polymers; maltodextrins; poly(2-ethyl-2-oxazoline); poly(ethyleneimine); polyurethane; hydrogels; crosslinked polyacrylic acids; poly(ethylene oxide), and combinations or blends of any of the foregoing. In certain aspects, the one or more swellable polymers may increase to a size sufficient to be retained in the stomach for an extended period of time.

When the optional one or more swellable polymers is present in the extended release granules, delayed release granules, or both extended and delayed release granules, the total amount present may vary within a wide range, preferably from about 0.1% by weight to about 50% by weight, including about 2% to about 40% by weight, about 10% to about 40% by weight, and about 2% by weight to about 20% by weight of the total composition, including about 5%, 10%, 15%, 20%, 30%, 40%, and 50% by weight and ranges encompassing and bordered by such amounts. The amount of the one or more swellable polymer component present may depend, at least in part, upon the amount and identity of each of the other components present (the amounts and physical characteristics of the at performance enhancing components of the immediate release component and extended or delayed release granules and any fatty material(s), barrier coatings, and additives), and the identity and properties of the particular polymer(s), with the object being to achieve a granule formulation which exhibits extended release or delayed release and which provides the previously-described neutral buoyancy in a dispersion medium, such as an aqueous medium.

Thus, in certain aspects a performance enhancing immediate and extended release composition is provided that comprises an immediate release powder and extended release granules, the granules comprising a core and a barrier coating layer over the core. The immediate release powder comprises at least one first performance enhancing component selected from the group consisting beta alanine, betaine anhydrous, citrulline malate, creatine, N-acetyl L-tyrosine, caffeine, niacinamide, and bioperine black pepper extract. The core of the extended release granules comprises at least one second performance enhancing component, one or more fatty material, and one or more swellable polymers. The at least one second performance enhancing component of the core is selected from the group consisting of betaine, caffeine, niacin, N-acetyl L-tyrosine citrus aurantium, alpha yohimbine, and vitamin 12. The one or more fatty material of the core comprises hydrogenated vegetable oil. The one or more swellable polymers of the core is selected from the group consisting of microcrystalline cellulose and hydroxypropyl methylcellulose. The barrier coating layer comprises hydroxypropylmethyl cellulose and ethylcellulose. In certain aspects, the immediate release powder is soluble in an aqueous medium. In some aspects, the bulk density of the extended release granules when dispersed in an aqueous medium, e.g. water, is from about 0.3 g/cc to about 0.75 g/cc. In certain aspects, the extended release granules will remain suspended once dispersed in an aqueous medium, without either sinking or floating within about the first 15 seconds to about 1 and 15 seconds of agitation. Such a composition can be used in processes for enhancing athletic performance or preventing fatigue that include administering the instantly-disclosed composition to a mammalian subject, optionally a human, wherein the administration is performed at a time suitable for enhancing athletic performance or preventing fatigue. In certain aspects, the composition can be administered in the form of an oral suspension.

In another aspect, a performance enhancing immediate and extended release composition is provided that comprises an immediate release powder and extended release granules, the granules comprising a core and a barrier coating layer over the core. The immediate release powder comprises at least one first performance enhancing component selected from the group consisting leucine, isoleucine, valine, betaine anhydrous, citrulline, glutamine, and branched chain amino acids, coconut water powder, astragalus membranaceus and panax notoginseng, and piper nigrum fruit extract. The core of the extended release granules comprises at least one second performance enhancing component, one or more fatty material, and one or more swellable polymers. The at least one second performance enhancing component of the core is selected from the group consisting of leucine and branched chain amino acids. The one or more fatty material of the core comprises hydrogenated vegetable oil. The one or more swellable polymers of the core is selected from the group consisting of microcrystalline cellulose and hydroxypropyl methylcellulose. The barrier coating layer comprises ethylcellulose. In certain aspects, the immediate release powder is soluble in an aqueous medium. In some aspects, the bulk density of the extended release granules when dispersed in an aqueous medium, e.g. water, is from about 0.3 g/cc to about 0.75 g/cc. In certain aspects, the extended release granules will remain suspended once dispersed in an aqueous medium, without either sinking or floating within about the first 15 seconds to about 1 and 15 seconds of agitation. Such a composition can be used in processes for enhancing athletic performance or preventing fatigue that include administering the instantly-disclosed composition to a mammalian subject, optionally a human, wherein the administration is performed at a time suitable for enhancing athletic performance or preventing fatigue. In certain aspects, the composition can be administered in the form of an oral suspension.

In a further aspect, a performance enhancing immediate and extended release composition is provided that comprises an immediate release powder and extended release granules, the granules comprising a core and a barrier coating layer over the core. The immediate release powder comprises at least one first performance enhancing component selected from the group consisting citrulline, agmatine sulfate, arginine silicate inositol, norvaline, niacin, aswagandha extract, and piper nigrum fruit extract. The core of the extended release granules comprises at least one second performance enhancing component, one or more fatty material, and one or more swellable polymers. The at least one second performance enhancing component of the core is selected from the group consisting of norvaline, niacin, and grape seed extract polyphenols. The one or more fatty material of the core comprises hydrogenated vegetable oil. The one or more swellable polymers of the core is selected from the group consisting of microcrystalline cellulose and hydroxypropyl methylcellulose. The barrier coating layer comprises ethylcellulose. In certain aspects, the immediate release powder is soluble in an aqueous medium. In some aspects, the bulk density of the extended release granules when dispersed in an aqueous medium, e.g. water, is from about 0.3 g/cc to about 0.75 g/cc. In certain aspects, the extended release granules will remain suspended once dispersed in an aqueous medium, without either sinking or floating within about the first 15 seconds to about 1 and 15 seconds of agitation. Such a composition can be used in processes for enhancing athletic performance or preventing fatigue that include administering the instantly-disclosed composition to a mammalian subject, optionally a human, wherein the administration is performed at a time suitable for enhancing athletic performance or preventing fatigue. In certain aspects, the composition can be administered in the form of an oral suspension.

In some aspects, the extended release granules, delayed release granules, or both extended and delayed release granules of the powder blend may be milled to achieve a desired size range. The particle size range of the extended release granules, delayed release granules, or both extended and delayed release granules of the powder blend can also impact the buoyancy of the granules. For example, surface tension plays a role in the buoyancy of the extended release granules, delayed release granules, or both extended and delayed release granules of the powder blend once dispersed in a dispersion medium. If the particle size of the granules is too small, the excess surface tension makes it difficult for the granules to suspend and they will only float on top of the dispersion medium. Likewise, if the surface tension is too large, the reduced surface area results in granules that sink in the dispersion medium. In one aspect, to achieve the desired neutral buoyancy of the extended release granules in a dispersion medium (e.g. aqueous medium), delayed release granules, or both extended and delayed release granules, the granules can be milled or passed through a sieve to remove agglomerates after granulation and to provide a particle size ranging from about 150 μm to about 1200 μm, or any value or range therebetween. In other aspects, the granules can be milled or passed through a sieve to remove agglomerates after granulation and to provide a particle size ranging from about 425 μm to about 850 μm, or any value or range therebetween. These particles can be either regularly or irregularly shaped. These particle sizes may be determined using sieve analysis through a sieve shaker having USP standard wire mesh sieves conforming to ASTM specifications (e.g. 16, 20, 30, 40, 60, or 80 mesh screen, optionally a screen of 10 to 80 mesh). A particle prior to coating is optionally sized to 10 to 30 mesh or any value or range therebetween, optionally 30 mesh, 25 mesh, 20 mesh, 18 mesh, 16 mesh, 14 mesh, 12 mesh, or 10 mesh.

In certain aspects, the extended release granules, delayed release granules, or both extended and delayed release granules optionally includes one or more additives including but not limited to, e.g., one or more of a diluent, binder, lubricant, disintegrant, stabilizer, surfactant, glidant, sweetener, a preservative, sodium citrate; silica; flavoring agents, coloring agents, preservatives, or other components. The choice of which such materials to us, if any, and the amounts to be utilized are considered to be within the abilities of one of skilled in the art, in view of the disclosure herein. However, additives which might adversely affect the neutral buoyancy of the extended release granules, delayed release granules, or both extended and delayed release granules, should either not be used or only be used in quantities insufficient to cause a substantial negative effect upon the neutral buoyancy or other characteristics of the composition.

Exemplary diluents may include, but are not limited to calcium carbonate, calcium phosphate dibasic, calcium phosphate tribasic, calcium sulfate, microcrystalline cellulose, microcrystalline silicified cellulose, powdered cellulose, dextrate, dextrose, fructose, lactitol, lactose anhydrous, lactose monohydrate, lactose dihydrate, lactose trihydrate, mannitol, sorbitol, starch, pregelatinized starch, sucrose, talc, xylitol, maltose, maltodextrin, maltitol

Exemplary binders may include, but are not limited to, starch (including corn starch and pregelatinized starch), gelatin, sugars (including sucrose, glucose, dextrose and lactose), polyethylene glycol, waxes, and natural and synthetic gums, e.g., acacia sodium alginate, polyvinylpyrrolidone, cellulosic polymers (including hydroxypropyl cellulose, hydroxypropyl methylcellulose, methyl cellulose, microctystalline cellulose, ethyl cellulose, hydroxyethyl cellulose, and the like), and Veegum. Examples of polyvinylpyrrolidone include povidone, copovidone and crospovidone.

Exemplary lubricants may include, but are not limited to magnesium stearate, calcium stearate, stearic acid, and hydrogenated vegetable oil (e.g. comprising hydrogenated and refined triglycerides of stearic and palmitic acids).

Exemplary disintegrants may include, but are not limited to starches, sodium starch glycolate, croscarmellose sodium, clays, celluloses, algins, gums, or crosslinked polymers (e.g., crosslinked polyvinyl pyrrolidone), alginic acid, carbon dioxide, carboxymethylcellulose calcium, carboxymethylcellulose sodium, microcrystalline cellulose, powdered cellulose, croscarmelose sodium, crospovidone, sodium docusate, gaur gum, hydroxypropyl cellulose, methylcellulose, polacrilin potassium, poloxamer, povidone, sodium alginate, sodium glycine carbonate, sodium lauryl sulfate, pregelatinized starch, low-substituted hydroxypropyl cellulose.

Fillers include, for example, materials such as kaolin, powdered cellulose, and microcrystalline cellulose, as well as soluble materials such as mannitol, urea, sucrose, lactose, lactose monohydrate, dextrose, sodium chloride, and sorbitol.

Exemplary sweeteners may include those sweeteners well known in the art, including both natural and artificial sweeteners. Thus, exemplary sweeteners may include water-soluble sweetening agents such as monosaccharides, disaccharides, and polysaccharides such as xylose, ribose, glucose, mannose, galactose, fructose, high fructose corn syrup, dextrose, sucrose, sugar, maltose, partially hydrolyzed starch, or corn syrup solids and sugar alcohols such as sorbitol, xylitol, mannitol and mixtures thereof. Additional exemplary sweeteners include optionally sugar or sugar substitute (e.g. sucralose (1,6-Dichloro-1,6-dideoxy-β-D-fructofuranosyl-4-chloro-4-deoxy-α-D-galactopyranoside), aspartame, and the like.

Exemplary preservatives may include sodium benzoate, benzoic acid, potassium sorbate, salts of edetate (also known as salts of ethylenediaminetetraacetic acid, or EDTA, such as disodium EDTA), parabens (e.g., methyl, ethyl, propyl or butyl-hydroxybenzoates, etc.), and sorbic acid. Other chelating agents, e.g., nitrilotriacetic acid (NTA); ethylenediaminetetracetic acid (EDTA), hydroxyethylethylenediaminetriacetic acid (HEDTA), diethylenetriaminepentaacetic acid (DPTA), 1,2-Diaminopropanetetraacetic acid (1,2-PDTA); 1,3-Diaminopropanetetraacetic acid (1,3-PDTA); 2,2-ethylenedioxybis[ethyliminodi(acetic acid)] (EGTA); 1,10-bis(2-pyridylmethyl)-1,4,7,10-tetraazadecane (BPTETA); ethylenediamine (EDAMINE); Trans-1,2-diaminocyclohexane-N,N,N′,N′-tetraacetic acid (CDTA); ethylenediamine-N,N′-diacetate (EDDA); phenazine methosulphate (PMS); 2,6-Dichloro-indophenol (DCPIP); Bis(carboxymethyl)diaza-18-crown-6 (CROWN); porphine; chlorophyll; dimercaprol (2,3-Dimercapto-1-propanol); citric acid; tartaric acid; fumaric acid; malic acid; and salts thereof can be utilized as preservatives. Each preservative must be evaluated in each formulation to assure the compatibility and efficacy of the preservative. Methods for evaluating the efficacy of preservatives in compositions and formulations are known to those skilled in the art.

Exemplary flavoring agents may include both natural and artificial flavors, and mints such as peppermint, menthol, artificial vanilla, chocolate, cinnamon, various fruit flavors, both individual and mixed, essential oils (i.e. thymol, eucalyptol, menthol and methyl salicylate) and the like.

In one aspect, the extended release granules, delayed release granules, or both extended and delayed release granules are formed into a solid unit dose or solid preparation. Such granules may take the form of a powder. Other solid preparations include beads, beadlets, capsules, tablets (e.g. oral disintegrating tablet), or other forms suitable for oral administration to a subject that is capable of suspension in a dispersion medium, such as an aqueous medium or other liquid.

In some aspects, the above-described immediate release powder and extended release granules, delayed release granules, or both extended and delayed release granules, are optionally suspended, diluted, solubilized, or otherwise combined with a dispersion medium to provide an oral suspension. Thus, in certain aspects, a performance enhancing immediate and extended release oral suspension comprising an immediate release component comprising at least one performance enhancing component; an extended release granule component comprising a core, the core comprising at least one performance enhancing component and one or more fatty materials; and a dispersion medium is provided. A dispersion medium is optionally an aqueous solution or other liquid. Any suitable aqueous solution may be used, such as water, milk, fruit, juice, alcohol, or the like. Organic solutions may or may not also be used for the dispersion medium. The dispersion medium is optionally non-toxic or used in a non-toxic amount. In some aspects, the dispersion medium may include water a from about 75 wt % to about 99.5 wt % of the dispersion medium, or any value or range in between. In some aspects, a dispersion medium consists of water. In some aspects, a dispersion medium optionally excludes a pH modifier. A dispersion medium optionally excludes a thickening agent defined herein as a material that increases the viscosity of the dispersion medium relative to a dispersion medium absent the thickening agent whereby a thickening agent is not a performance enhancing supplement. A dispersion medium following combination with a first and second component optionally has a pH of about 2.0 to about 9.0, optionally a pH in excess of about 5.5, optionally a pH of from about 6.5 to 8.0.

The instantly-disclosed compositions can be administered by any desirable route. Optionally, the composition is administered orally. An administration time is optionally before, during or following exercise. Optionally, the composition is administered orally prior to exercise or during exercise.

In some aspects, a composition is administered by adding a dispersion medium, optionally water, to a substantially dry mixture of first component and second component. A first component optionally fully or partially solubilizes in the dispersion medium and the second component is suspended in the dispersion medium for such a time sufficient for a subject to orally consume the composition. As such processes are provided for enhancing athletic performance or preventing fatigue that include administering a the instantly-disclosed composition(s) as provided to a mammalian subject, optionally a human, wherein the administration is performed at a time suitable for enhancing athletic performance or preventing fatigue. Thus, processes are provided for maintaining vasodilation during and after a workout, stimulating muscle synthesis and repair over an extending period of time, and/or preventing athletic fatigue, such as sustaining energy levels and avoiding a subsequent energy level crash, that include administering the instantly-disclosed immediate and extended release performance enhancing supplement compositions. An administration time is optionally from 0 to 30 minutes prior to exercise or other athletic activity, during athletic activity, or combinations thereof.

The foregoing description is illustrative of particular aspects of the invention, but is not meant to be a limitation upon the practice thereof. In order that various aspects may be more readily understood, reference is made to the following examples which are intended to illustrate various aspects, but do not limit the scope thereof.

### EXAMPLES

### Example 1: Method of Granulating and Forming the Performance Enhancing Immediate and Extended Release Composition

The extended release granules and/or delayed release granules are made using a high shear granulation process, followed by a coating process. The desired time release, e.g. sustained release or delayed release, is achieved both by the granulation composition and/or the coating.

The high shear process typically begins by adding the dry powders of the formulation to the high shear granulator, which is a sealed “mixing bowl” with an impellor that rotates through the powder bed, and a chopper blade that breaks up over-agglomerates that can form during the process. There are typically three phases to the high shear process, dry mixing, solution addition, or wet massing and high shear granulation.

In the first phase, dry powders, such as the at least one performance enhancing component (Table A), the one or more fatty materials (Table B), optionally the one or more swellable polymers (Table C), and various optional additives are mixed together by the impeller blade which rotates through the powder bed, creating a “roping” vortex of powder movement. The one or more fatty acids, which can be low density fatty powders, are optionally granulated the at least one performance enhancing component with low density fatty powders—to target a bulk density of the final granule formulation will be from about 0.30 g/cc to about 0.75 g/cc, including any value or range therebetween, so that the final granule formulation will be suspendable and will exhibit neutral buoyancy in an aqueous medium. The one or more swellable polymers are also optionally granulated with the at least one performance enhancing component to modify, prolong, and/or slow the release over time of the at least one performance enhancing component from the granules. The dry mixing phase typically lasts for only a few minutes.

In the second phase of the process, a granulating liquid is added to the sealed product container, usually by use of a peristaltic pump. The solution can contain a binder with sufficient viscosity to cause the wet massed particles to stick together or agglomerate. However, a binder may be incorporated only in the granulating solution or only in the dry powder. If the binder is only in the dry powder, then water is used as the granulating solution. It is common for the solution addition phase to last over a period of from three to five minutes. While the impeller is rotating rather slowly during this step of the process, the chopper blade is turning at a fairly high rate of speed to chop up over-sized agglomerates, while not interfering with the impellers movement.

Once the binder solution is added to the product container, the final stage of the granulation process begins. In this phase, high shear forces are generated as the impeller blades push through the wet massed powder bed, further distributing the binder and intimately mixing the ingredients contained therein until the desired granule particle size and density end-points are reached. Granule particle size and density end-points are often determined by the power consumption and/or torque on the impeller. The extended release granules and delayed release granules will have a particle size ranging from about 150 μm to about 1200 μm, or any value or range therebetween. Similarly, the granules can be milled or passed through a sieve to remove agglomerates after granulation and to provide a particle that will have a particle size ranging from about 425 μm to about 850 μm, or any value or range therebetween.

Once the high shear granulation process is completed, the material is transferred to a fluid bed dryer, or alternatively, can be spread out onto trays which are then placed in a drying oven, where the product is dried until the desired moisture content is achieved.

Once dried, the granules undergo a coating process. The barrier coating (Table D) confers either extended release (e.g. ethylcelullose based coating) or delayed release properties (e.g. an enteric coating such as a shellac coating) to the granules. For coating, the barrier coat can be applied, e.g., as either an aqueous suspension or dispersion, over the extended release granules, delayed release granules, or both extended and delayed release granules, and forms a separate layer thereon.

The extended and delayed release granules of the instant compositions optionally includes the components as found in Tables A-D, including the at least one performance enhancing component (Table A), the one or more fatty materials (Table B), optionally the one or more swellable polymers (Table C), and optionally the barrier coating (Table D).

TABLE A
Performance Enhancing Components

| Ingredient | Weight % of Granule |
|---|---|
| Betaine Anhydrous (Trimethyl Glycine) | 0%-30% |
| Betaine | 0%-20% |
| Caffeine | 0%-20% |
| N-Acetyl L-Tyrosine | 0%-15% |
| Niacin/Nicotinic Acid Vit B3 | 0%-10% |
| Vitamin B12 | 0%-5% |
| Citrus Auranium | 0%-5% |
| Citrulline | 0%-30% |
| Creatine | 0%-20% |
| Alpha Yohimbine | 0%-2% |
| Leucine | 0%-60% |
| Isoleucine | 0%-25% |
| Valine | 0%-25% |
| Glutamine | 0%-25% |
| Agmatine Sulfate | 0%-15% |
| Arginine Silicate Inositol | 0-15% |
| Pepform BCAA 2:1:1 | 0%-15% |
| Astragalus membranaceus and Panax notoginseng | 0%-5% |
| Beta-Alanine | 0%-40% |
| Norvaline | 0%-50% |
| Niacin Usp/Vitamin B3 | 0%-15% |
| Grape Seed Extract | 0%-15% |
| Piper Nigrum Fruit Extract | 0%-2% |
| Ashwagandha Extract | 0%-15% |

TABLE B
Granule Fatty Material

| Ingredient | Weight % of Granule |
|---|---|
| Hydrogenated Vegetable Oil | 15%-60% |
| Stearic acid | 15%-60% |
| Fractionated Vegetable Oils | 15%-60% |
| Fatty Acid Esters of Glycerol | 15%-60% |

TABLE C
Granule Swellable Polymers

| Ingredient | Weight % of Granule |
|---|---|
| Hydroxypropyl methylcellulose | 0%-25% |
| Microcrystalline cellulose | 0%-25% |
| Ethylcellulose | 0%-25% |
| Methylcellulose | 0%-25% |
| Gums | 0%-25% |

TABLE D
Granule Coating

| Ingredient | Weight % of Granule |
|---|---|
| Ethylcellulose | 0%-10% |
| Shellac | 0%-10% |
| Hydroxypropyl methylcellulose | 0%-10% |

The extended and delayed release granules of the instant compositions are subsequently mixed with the immediate release powder that includes at least one performance enhancing component (Table A). The performance enhancing component of the extended release granules, delayed release granules, or both extended and delayed release granules includes the same, different, additional, or fewer at least one performance enhancing component of relative to the at least one performance enhancing component of the immediate release powder. The extended release granules and/or delayed release granule and the immediate release powder can be mixed to form a powder blend, or can be combined in a dispersion medium (e.g. an aqueous medium such as water or sports drink) to form an oral suspension.

### Example 2: Forming Extended Release Granules

Extended release granules are formed by high shear mixing substantially as understood in the art. Briefly, one or more performance enhancing components (e.g. caffeine, beta alanine (e.g. CAROSYN), trimethyl glycine, creatine, tyrosine, niacin or derivatives, plant extract (e.g. grape seed extract or Piper nigrum), norvaline, leucine, BCAA, methylcobalamin, tyrosine, and/or others as described herein) is charged to a Littleford W-10 shearmixer with a hot water jacket to allow circulating hot water to keep the vessel hot. After mixing for 1 minute at 1000 RPM, spray chilled fat powder (Sterotex HM®) is added to the vessel. The work input is increased to 2000 RPM and then adjusted down to about 600 RPM for 5 minutes. The resulting particles are sized to 10-30 mesh. Extended release granules can include an extended release composition (e.g. HPMC, ethylcellulose, microcrystalline cellulose), and can further include an optional extended release material coated onto the surface. Likewise, extended release granules in which an extended release composition (e.g. HPMC, ethylcellulose, microcrystalline cellulose) is not added to the granule itself, the extended release material may be coated onto the surface.

The granules are subjected to dissolution testing for release of the active into a dispersion medium using the basket method. Briefly, the granules are placed in water housed in a basket and rotated (25-150 RPM) at a constant temperature (35° C.). Samples are drawn at various time intervals and subjected to analysis. Granules employing caffeine are formed to have a release profile of NMT 20% 20 min and NLT 80% 60 min. In other aspects, granules employing caffeine are formed to have a release profile of NMT 10% 20 min and NLT 80% 40 min. Granules employing BCAA are formed to have a release profile of NMT 20% 1 hour and NLT 80% 4 hours. In other aspects, granules employing BCAA are formed to have a release profile of NMT 10% 1 hour, NMT 30% in 2 hours, and NLT 80% 4 hours. Granules employing norvaline have a release profile of NMT 70% at 30 min.

Various modifications of the present invention, in addition to those shown and described herein, will be apparent to those skilled in the art of the above description. Such modifications are also intended to fall within the scope of the appended claims.

It is appreciated that all reagents are obtainable from commercial sources known in the art unless otherwise specified.

Patents, publications, and applications mentioned in the specification are indicative of the levels of those skilled in the art to which the invention pertains. These patents, publications, and applications are incorporated herein by reference to the same extent as if each individual patent, publication, or application was specifically and individually incorporated herein by reference.

The foregoing description is illustrative of particular aspects of the invention, but is not meant to be a limitation upon the practice thereof.

1. A performance enhancing immediate and extended release composition comprising:
(a) an immediate release powder comprising at least one first performance enhancing component; and
(b) extended release granules comprising a core, the core comprising at least one second performance enhancing component and one or more fatty materials;
wherein the immediate release powder is soluble in an aqueous medium.

2. The performance enhancing immediate and extended release composition of claim 1, wherein the one or more fatty materials comprise powdered fats.

3. The performance enhancing immediate and extended release composition of claim 2, wherein the one or more fatty materials are selected from the group consisting of hydrogenated vegetable oil, stearic acid, fractionated vegetable oil, glycerol fatty acid ester, and combinations thereof.

4. The performance enhancing immediate and extended release composition of claim 1, wherein the particle size of extended release granules is from about 425 μm to about 850 μm.

5. The performance enhancing immediate and extended release composition of claim 1, wherein the extended release granules further comprise a barrier coating layer.

6. The performance enhancing immediate and extended release composition of claim 5, wherein the barrier coating comprises ethylcellulose.

7. The performance enhancing immediate and extended release composition of claim 5, wherein the barrier coating comprises hydroxypropyl methylcellulose.

8. The performance enhancing immediate and extended release composition of claim 1, wherein the core of the extended release granules further comprises one or more swellable polymers.

9. The performance enhancing immediate and extended release composition of claim 1, wherein the immediate release powder further comprises at least one viscosity modifier.

10. The performance enhancing immediate and extended release composition of claim 9, wherein the viscosity modifier is selected from the group consisting of guar gum, xantham gum, and silica.

11. The performance enhancing immediate and extended release composition of claim 1, wherein a bulk density of the extended release granules is from about 0.3 g/cc to about 0.75 g/cc.

12. The performance enhancing immediate and extended release composition of claim 1, wherein the at least one performance enhancing first component of the immediate release powder comprises at least one active selected from the group consisting of a vitamin, a mineral, protein, creatine, an amino acid, a carbohydrate, a fatty acid, a stimulant, pyruvate, and a citric acid cycle intermediate.

13. The performance enhancing immediate and extended release composition of claim 1, wherein the at least one performance enhancing second component of the extended release granules comprises at least one active selected from the group consisting of a vitamin, a mineral, protein, creatine, an amino acid, a carbohydrate, a fatty acid, a stimulant, pyruvate, and a citric acid cycle intermediate.

14. The performance enhancing immediate and extended release composition of claim 1, wherein the extended release granules further comprise at least one excipient selected from the group consisting of a diluent, a binder, a lubricant, a disintegrant, a flavoring agent, a coloring agent, a stabilizer, a surfactant, a glidant, a preservative, and a sweetener.

15. The performance enhancing immediate and extended release composition of claim 1, wherein the extended release granules are configured to remain suspended once dispersed in an aqueous medium without either sinking or floating from within about the first 15 seconds of agitation to within about 1 minute and 15 seconds of agitation.

16. A performance enhancing immediate and extended release oral suspension, said oral suspension comprising:
(a) an immediate release component comprising at least one first performance enhancing component; and
(b) extended release granule component comprising a core, the core comprising at least one second performance enhancing component and one or more fatty materials; and
(c) a dispersion medium.

17-40. (canceled)

41. A process of reducing fatigue or enhancing exercise performance in a subject comprising administering to the subject the composition of claim 1, wherein the extended release granules optionally have a bulk density from about 0.3 g/cc to about 0.75 g/cc;
the step of administering prior to or during exercise.

42. The process of claim 41 wherein said extended release granules comprise caffeine in the core, the release profile of the caffeine in an aqueous medium of not more than 10 weight percent caffeine in 20 minutes and not less than 80 weight percent caffeine in 40 minutes.

43. The process of claim 41 wherein said extended release granules comprise free leucine in the core, the release profile of the leucine in an aqueous medium of not more than 10 weight percent leucine in 60 minutes and not less than 80 weight percent leucine in 4 hours.

44. The process of claim 41 wherein said extended release granules comprise norvaline in the core, the release profile of the norvaline in an aqueous medium of not more than 70 weight percent norvaline in 30 minutes.

45-46. (canceled)
